(19) United States
(12) Patent Application Publication
(10) Pub. No.: US 2010/0134526 A1
(43) Pub. Date: Jun. 3, 2010

(54) DISPLAY DEVICE AND METHOD FOR DRIVING DISPLAY DEVICE

(76) Inventor: Kohei Nanbu, Osaka (JP)

Correspondence Address: HARNESS, DICKEY & PIERCE, P.L.C., P.O. BOX 8910, RESTON, VA, 20195, US

(21) Appl. No.: 12/452,284

(22) PCT Filed: Jul. 3, 2008
(86) PCT No.: PCT/JP2008/062105

§ 371 Date: Dec. 23, 2009

(30) Foreign Application Priority Data
Jul. 20, 2007 (JP) 2007 190103

(51) Int. Cl. G09G 5/10; G09G 3/36

(52) U.S. Cl. 345/690; 345/102

(57) ABSTRACT

In one embodiment of the present invention, a transmissive liquid crystal display device includes a display panel, a backlight, and an inverter section. The liquid crystal display device further includes: a comparison process section for judging whether or not a voltage supplied to the inverter section is not less than a predetermined voltage required for normally driving the inverter section; a lighting state detection section for detecting lighting state of the backlight; and a backlight failure detection section for (i) judging whether or not the backlight has failed in accordance with each of processed results, and outputting a signal in accordance with a judged result. The backlight failure detection section outputs a backlight failure signal, in a case where (i) the voltage is not less than the predetermined voltage and (ii) the backlight is not lighting normally. Whereas, the backlight failure detection section does not output the backlight failure signal, in a case where the voltage is less than the predetermined voltage. According to the configuration of the display device including a backlight, a cause of improper lighting of the backlight can be identified. This allows maintenance work to be carried out efficiently.

### TECHNICAL FIELD

The present invention relates to a display device such as a transmissive liquid crystal display device and a method for driving a display device.

### BACKGROUND ART

There are various types of color displays that have been in practical use. Thin displays are classified broadly into (i) self-luminous displays such as PDPs (plasma display panels) and (ii) nonluminous displays typified by LCDs (liquid crystal displays). A known example of an LCD, i.e., a nonluminous display is a transmissive LCD having a backlight disposed on the back surface side of a liquid crystal panel.

FIG. 11 is a cross-sectional view illustrating a typical structure of a transmissive LCD. This transmissive LCD has a backlight 110 disposed on the back surface side of a liquid crystal panel 100. The liquid crystal panel 100 includes: a pair of transparent substrates 101 and 102; a liquid crystal layer 103 disposed between the transparent substrates 101 and 102; and polarizing plates 104 and 105 provided on the respective outer surfaces of the transparent substrates 101 and 102. The liquid crystal panel 100 further includes a color filter 106 so as to carry out a color display.

Although not illustrated in FIG. 11, each of the transparent substrates 101 and 102 has an electrode layer and an alignment film which are formed on its inner surface. In response to controlling of a voltage that is applied to the liquid crystal layer 103, the amount of light that travels through the liquid crystal panel 100 is controlled in individual pixels. That is, the transmissive LCD carries out a display control by controlling the amount of light, emitted from the backlight 110, that travels through the liquid crystal panel 110.

A white backlight, containing the wavelengths of three colors RGB necessary for a color display, is mainly used as the backlight 110. The backlight 110 is combined with the color filter 106 so as to adjust the transmittance of light that travels through each of the colors RGB. This makes it possible to arbitrarily set the luminance and hue of a pixel. It should be noted that some backlight 110 includes light sources for the respective colors RGB.

For example, according to the above LCD, the liquid crystal panel 100, including pixels corresponding to RGB regions of the color filter 106, has a shutter function. The shutter function controls the transmittance of light that travels through each of the pixels in accordance with the display information to be outputted. Specifically, the shutter function controls the transmittance of the light that travels through each of the pixels by controlling the transmittance by a predetermined step which falls within the range of 0 to 100%. This causes the intensity of the light that travels through each of the pixels to be controlled. Theoretically, in cases where 100% of the light emitted from the backlight 110 is traveled through, the intensity of a color component corresponding to the light emitted from the backlight is outputted from a corresponding pixel as it is, thereby obtaining a maximum luminance. On the other hand, a transmittance of 0% causes a black display. According to the ordinary transmissive LCD that is configured so that the liquid crystal panel 100 has the shutter function causing a display control, the backlight 110 continues to emit light at a certain level of luminance.

The backlight sometimes does not light normally due to the reasons such as: an end of a product life or breakage of a fluorescent tube (such as a cold-cathode tube) used as a light source of the backlight; a bad electrical contact of a connector via which an inverter and an electrode of the fluorescent tube are connected with each other; and disconnection of a lead wire. Such a failure of the backlight causes a deterioration in display quality, and ultimately causes the display panel not to display anything at all. In particular, in a case where the display panel does not display anything, it becomes difficult to determine whether the failure is caused by a breakdown of the display panel or a breakdown of the backlight. Accordingly, it takes a lot of trouble with a check and replacement work for the faulty section. This allows maintenance work not to be carried out efficiently.

In order to address the problem, for example, Patent Literature 1 discloses a technique for easily identifying a cause for which a backlight of a liquid crystal display device has failed so as to efficiently carry out maintenance work.

FIG. 12 is a block diagram schematically illustrating a configuration of the liquid crystal display device disclosed in Patent Literature 1. As shown in FIG. 12, the liquid crystal display device includes, in addition to components constituting a general liquid crystal display device, a backlight failure detection section 205 that detects a failure of a backlight 204; an optical sensor 206 that monitors a lighting state of the backlight 204; and a backlight failure indicator 207 that notifies, outside the liquid crystal display device, that the backlight 204 has failed. In a case where the backlight failure detection section 205 detects that the backlight 204 is not lighting, the backlight failure detection section 205 determines that the backlight 204 has failed, and allows the backlight failure indicator 207 to operate. Accordingly, in a case where the backlight 204 has failed and a liquid crystal panel 202 does not display anything, a user or an operator can recognize that the backlight 204 has failed. Therefore, the maintenance work can be carried out efficiently. More specifically, it is only necessary to check a fluorescent tube (serving as light source) and a connecting region where the backlight 204 is connected to an inverter, but it is no longer necessary to check the liquid crystal panel 202.

### Patent Literature 1

Japanese Patent Application Publication, Tokukaihei, No. 10-319865 A (Publication Date: Dec. 4, 1998)

### SUMMARY OF INVENTION

However, the conventional liquid crystal display device disclosed in Patent Literature 1 cannot clearly identify a cause which is not displayed on the liquid crystal panel. That is, it is difficult to identify a cause of a failure of the backlight even though the liquid crystal display device can determine whether the liquid crystal panel has failed or the backlight has failed. The causes of the failure of the backlight can include, for example, a failure of a power supply section that supplies electric power to the inverter, in addition to the above described causes such as the bad electrical contact and the breakage of the fluorescent tube. Causes of the failure of the power supply section can include, for example, a breakage of a component constituting the power supply section and a bad electrical contact caused by a component.

For example, in a case where the power supply section has failed in the conventional liquid crystal display device, a voltage required for the backlight to light is not supplied to the backlight. This causes the backlight not to light, and it is therefore determined that the backlight has failed. Accordingly, even though the backlight has not failed, the fluorescent tube (serving as light source) and the inverter, etc. have to be checked. On this account, it takes time to identify a cause of the failure. According to the conventional liquid crystal display device, it is determined that the inverter and/or the fluorescent tube have failed only based on a phenomenon that the backlight does not light. This makes it difficult to identify a real cause of the failure.

The present invention is accomplished in view of the problems, and its object is to provide a display device, including a backlight, which can identify a cause of improper lighting of the backlight so that maintenance work is efficiently carried out.

In order to attain the object, the display device of the present invention includes: (i) a transmissive display panel, (ii) a backlight that irradiates the display panel with light, and (iii) an inverter section that supplies a driving voltage to the backlight, in which a display is carried out by controlling an amount of transmission of the light with which the display panel is irradiated by the backlight, the display device further including: a comparison process section that judges whether or not a voltage supplied to the inverter section is not less than a predetermined voltage required for normally driving the inverter section; a lighting state detection section that detects a lighting state of the backlight; and a backlight failure detection section that (i) judges whether or not the backlight has failed, in accordance with a judged result of the comparison process section and a detected result of the lighting state detection section and (ii) outputs a signal which varies according to its judged result, the backlight failure detection section outputting a backlight failure signal indicating that the backlight has failed, in a case where (i) the voltage supplied to the inverter section is not less than the predetermined voltage and (ii) the backlight is not lighting normally, and the backlight failure detection section outputting no backlight failure signal, in a case where the voltage supplied to the inverter section is less than the predetermined voltage.

Moreover, in order to attain the object, a method for driving a display device, the display device including (i) a transmissive display panel, (ii) a backlight that irradiates the display panel with light, and (iii) an inverter section that supplies a driving voltage to the backlight, in which a display is carried out by controlling an amount of transmission of the light with which the display panel is irradiated by the backlight, the method including the steps of: (a) judging whether or not a voltage supplied to the inverter section is not less than a predetermined voltage required for normally driving the inverter section; (b) detecting a lighting state of the backlight; and (c) judging whether or not the backlight has failed, in accordance with a judged result in the step (a) and a detected result in the step (b), and outputting a signal which varies according to its judged result, in the step (c), a backlight failure signal, indicating that the backlight has failed, being outputted in a case where (i) the voltage supplied to the inverter section is not less than the predetermined voltage and (ii) the backlight is not lighting normally, and in the step (c), no backlight failure signal being outputted in a case where the voltage supplied to the inverter section is less than the predetermined voltage.

According to the configuration, the backlight failure signal indicating that the backlight has failed is outputted in a case where (i) the voltage supplied to the inverter section is not less than the predetermined voltage required for normally driving the inverter section and (ii) the backlight is not lighting normally. Moreover, no backlight failure signal is outputted in a case where the voltage supplied to the inverter section is less than the predetermined voltage.

That is, in a case where the voltage supplied to the inverter section is less than the predetermined voltage, no backlight failure signal is outputted even while the backlight is not lighting normally. In this case, the display panel cannot carry out a normal display process, and therefore nothing will be displayed or the display process will be carried out incompletely.

As such, no backlight failure signal is outputted even while the display panel cannot carry out the display process normally. Accordingly, the user or the operator can recognize that the improper display of the display panel is not caused by a failure of the backlight. Further, the user or the operator can surmise that the cause is not due to the backlight but, for example, is due to a failure of the power supply section which supplies a voltage to the inverter section. Accordingly, it is possible to omit a check, which has been conventionally required in maintenance work, for the backlight. This allows the maintenance work to be carried out efficiently.

In the display device, it is preferable that: the backlight failure detection section outputs a signal indicating that the backlight is normal, in a case where (i) the voltage supplied to the inverter section is not less than the predetermined voltage and (ii) the backlight is lighting normally; the backlight failure detection section outputs a backlight failure signal indicating that the backlight has failed, in a case where (i) the voltage supplied to the inverter section is not less than the predetermined voltage and (ii) the backlight is not lighting normally; and the backlight failure detection section outputs no backlight failure signal, in a case where the voltage supplied to the inverter section is less than the predetermined voltage.

According to the configuration, it is possible to understand the lighting state of the backlight in a case where the voltage supplied to the inverter section is not less than the predetermined voltage.

It is preferable that the display device further includes: a notification section that notifies outside of the lighting state of the backlight; and a notification control section that gives a notification command to the notification section in accordance with an output signal supplied from the backlight failure detection section so as to cause the notification section to notify outside of the lighting state of the backlight, the notification control section sending, to the notification section, a signal for causing the notification section to notify outside that the backlight has failed, in a case where the notification control section receives the backlight failure signal, and the notification control section sending, to the notification section, no signal for causing the notification section to notify outside that the backlight has failed, in a case where the notification control section receives no backlight failure signal.

With the configuration, the user or the operator can easily confirm whether or not the backlight has failed. This allows the maintenance work to be carried out efficiently.

It is preferable that the display device further includes: a notification section that notifies outside of the lighting state of the backlight; and a notification control section that gives a notification command to the notification section so as to cause the notification section to notify outside of the lighting state of the backlight, the notification control section sending, to the notification section, a signal for causing the notification section to notify outside that the backlight has failed, in a case where the notification control section receives the backlight failure signal, and the notification control section sending, to the notification section, a signal for causing the notification section to notify outside that the backlight is normal, in a case where the notification control section receives no backlight failure signal.

According to the configuration, in a case where the notification control section receives no backlight failure signal, the notification section notifies outside that the backlight is normal. This allows the user or the operator to understand whether or not the backlight has failed more certainly. Accordingly, the maintenance work can be carried out more efficiently.

It is preferable that the display device further includes: a power supply failure detection section that (i) judges whether or not the power supply section has failed in accordance with a judged result of the comparison process section and (ii) outputs a signal which varies according to its judged result, the power supply failure detection section outputting a power supply failure signal indicating that the power supply section has failed, in a case where the voltage supplied to the inverter section is less than the predetermined voltage.

According to the configuration, in a case where the voltage supplied to the inverter section is less than the predetermined voltage, the power supply failure signal indicating that the power supply section has failed is outputted. That is, in a case where the voltage supplied to the inverter section is less than the predetermined voltage, the backlight failure signal is not outputted but the power supply failure signal is outputted. Accordingly, the user or the operator can recognize that the improper display of the display panel is not caused by a failure of the backlight but caused by a failure of the power supply section. This makes it possible to carry out the maintenance work efficiently.

It is preferable that the display device further includes: a notification section that notifies outside of the lighting state of the backlight; and a notification control section that gives a notification command to the notification section in accordance with output signals of the backlight failure detection section and the power supply failure detection section so as to cause the notification section to notify outside of (i) the lighting state of the backlight and (ii) a state of the power supply section, the notification control section (i) sending, to the notification section, a signal for causing the notification section to notify outside that the power supply section has failed but (ii) sending, to the notification section, no signal for causing the notification section to notify outside that the backlight has failed, in a case where the notification control section receives the power supply failure signal.

With the configuration, the user or the operator can easily confirm whether or not the backlight has failed. This allows the maintenance work to be carried out efficiently.

It is preferable that the display device further includes: a notification section that notifies outside of the lighting state of the backlight; and a notification control section that gives a notification command to the notification section in accordance with output signals of the backlight failure detection section and the power supply failure detection section so as to cause the notification section to notify outside of (i) the lighting state of the backlight and (ii) a state of the power supply section, the notification control section (i) sending, to the notification section, a signal for causing the notification section to notify outside that the power supply section has failed and (ii) sending, to the notification section, a signal for causing the notification section to notify outside that the backlight is normal, in a case where the notification control section receives the power supply failure signal.

According to the configuration, in a case where the notification control section receives the power supply failure signal, the notification section notifies outside that (i) the power supply section has failed and (ii) the backlight is normal. This allows the user or the operator to understand a cause of the improper display of the display panel more certainly. Accordingly, the maintenance work can be carried out more efficiently.

It is preferable that the display device further includes: an inverter control section that controls whether to drive or stop the inverter section in accordance with an output signal of the backlight failure detection section, the inverter control section controlling the inverter section to stop supplying a voltage to the backlight, in a case where the inverter control section receives the backlight failure signal.

According to the configuration, in a case where the inverter control section receives the backlight failure signal, the voltage supplied from the inverter section to the backlight is stopped. Accordingly, it is possible to avoid various dangers such as discharge, firing, and an electrical shock to the operator due to abnormal rise in the output voltage from the inverter section when the backlight has failed.

In the display device, it is preferable the notification section is constituted by an externally viewable indicator display.

In the display device, it is preferable that the notification section is constituted by a speaker that produces a sound by which the lighting state of the backlight can be identified.

In the display device, it is preferable that the lighting state detection section judges the lighting state of the backlight by detecting an output voltage of a transformer in the inverter section, the output voltage being supplied to the backlight.

In the display device, it is preferable that the lighting state detection section judges the lighting state of the backlight by detecting an amount of light with which the display panel is irradiated by the backlight.

The display device is preferably configured such that the display device is a liquid crystal display device.

For a fuller understanding of the nature and advantages of the invention, reference should be made to the ensuing detailed description taken in conjunction with the accompanying drawings

### BRIEF DESCRIPTION OF DRAWINGS

FIG. 1 is a block diagram schematically illustrating the configuration of a liquid crystal display device according to Embodiment 1.

FIG. 2 schematically illustrates the configuration of a backlight in which fluorescent tubes are used, (a) of FIG. 2 illustrating an example of arrangement of the fluorescent tubes in the backlight, (b) of FIG. 2 illustrating an example of division of regions for the backlight in accordance with the example of arrangement of the fluorescent tubes.

FIG. 3 is a circuit diagram schematically illustrating the configuration of a backlight unit in the liquid crystal display device according to Embodiment 1.

FIG. 4 is a process flow chart showing Operation Example 1 of the liquid crystal display device according to Embodiment 1.

FIG. 5 is a block diagram illustrating another configuration of the liquid crystal display device according to Embodiment 1.

FIG. 6 is a process flow chart showing Operation Example 2 of the liquid crystal display device according to Embodiment 1.

FIG. 7 is a block diagram schematically illustrating the configuration of a liquid crystal display device according to Embodiment 2.

FIG. 8 is a process flow chart showing an operation of the liquid crystal display device according to Embodiment 2.

FIG. 9 is a block diagram illustrating another configuration of the liquid crystal display device according to Embodiment 2.

FIG. 10 is a process flow chart showing Operation Example 2 of the liquid crystal display device according to Embodiment 2.

FIG. 11 is a cross-sectional view illustrating a typical structure of a transmissive LCD.

FIG. 12 is a block diagram schematically illustrating the configuration of a conventional liquid crystal display device.

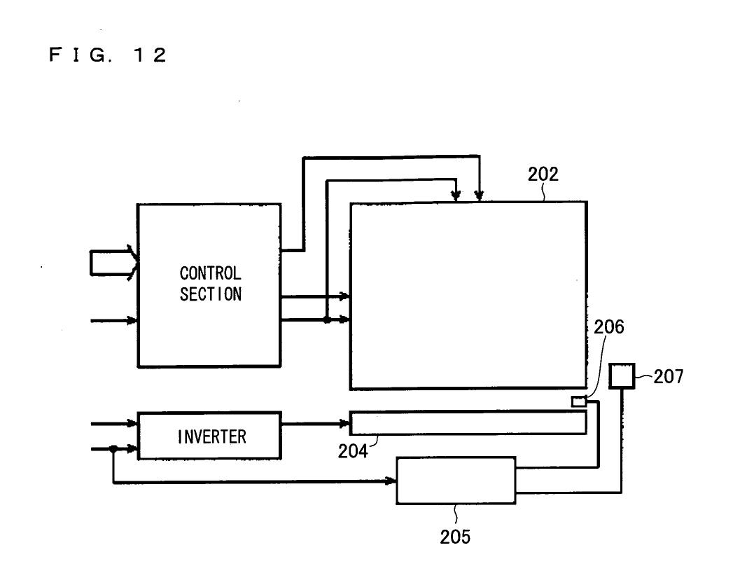

### REFERENCE SIGNS LIST

1: Power supply section
2: Inverter section
3: Backlight
4: Display panel (Liquid crystal panel)
5: Control section
51: Comparison process section
52: Lighting state detection section
53: Backlight failure detection section
54: Notification control section
55: Inverter control section
56: Power supply failure detection section
6: Notification section
7: Backlight unit
10, 20: Liquid crystal display device (display device)

### DESCRIPTION OF EMBODIMENTS

### Embodiment 1

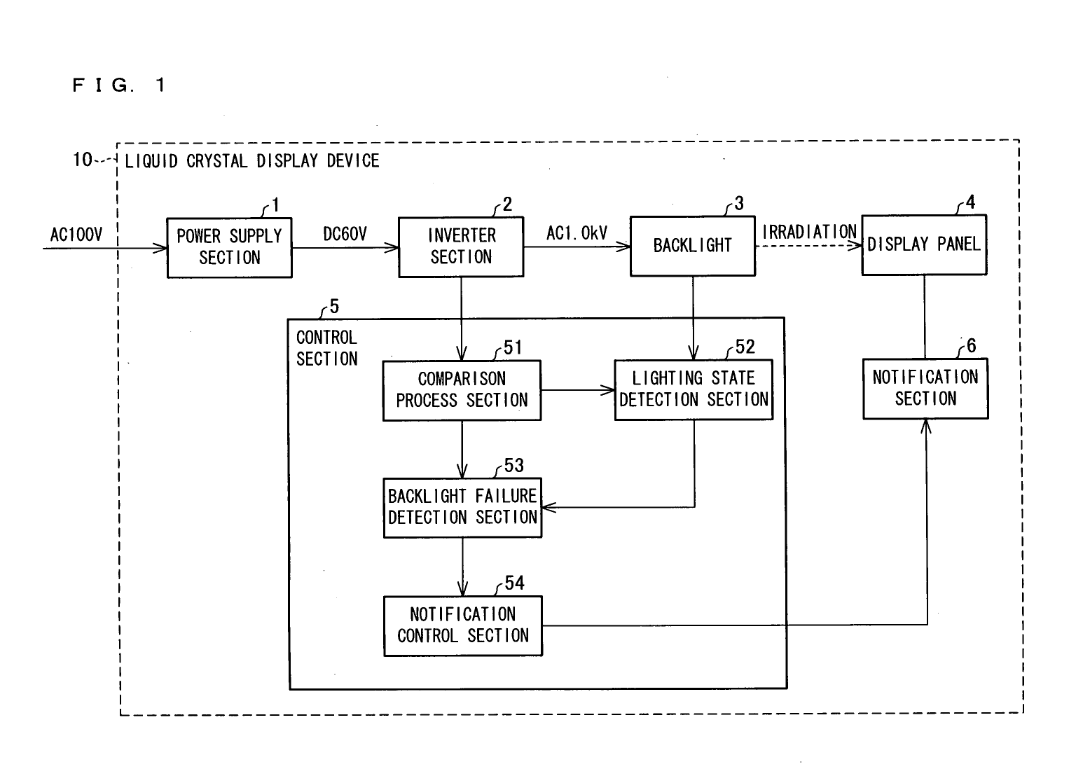

One embodiment of the present invention is described below with reference to FIGS. 1 through 6. In Embodiment 1, a liquid crystal display device is described as an example of a nonluminous display device that performs a display by controlling an amount of transmission of the light emitted from a backlight which is provided on the back surface side of a display panel.

First, the following description schematically deals with a configuration of a liquid crystal display device in accordance with Embodiment 1 with reference to FIG. 1. Note that the configuration shown in FIG. 1 is referred to as a configuration example 1-1.

As illustrated in FIG. 1, a liquid crystal display device 10 includes a power supply section 1, an inverter section 2, a backlight 3, a display panel 4, a control section 5, and a notification section 6. Other members, constituting the liquid crystal display device 10 such as a gate driving section, a source driving section, a common electrode driving section, and a controlling section having an operational section, have conventionally well-known functions. As such, the other members are neither illustrated nor described below.

The power supply section 1 converts an externally supplied AC voltage into an inverter-driving DC voltage. Specifically, the power supply section 1 converts AC 100 V into DC 60 V, for example.

The inverter section 2 is a conversion circuit that converts, into a backlight-driving AC voltage, the DC voltage supplied from the power supply section 1. More specifically, the inverter section 2 converts DC 60 V into AC 1.0 kV.

The backlight 3 is a light source that emits light in accordance with the driving voltage supplied from the inverter section 2, and irradiates the display panel 4 with the light.

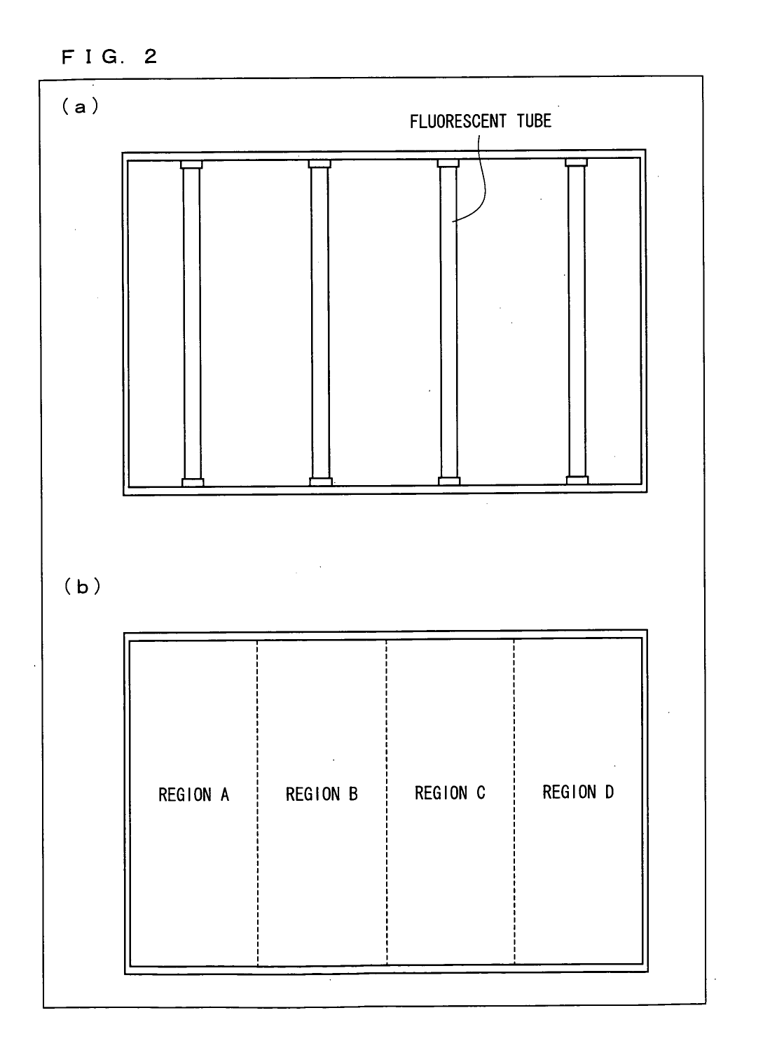

Fluorescent tubes (e.g., cold-cathode tubes) are often employed as a light source of the backlight 3 employed in the liquid crystal display device 10. For example, in cases where fluorescent tubes are provided in a backlight in which fluorescent tubes are employed as a light source (see (a) of FIG. 2), regions for the backlight can be divided in accordance with the arrangement of the fluorescent tubes (see (b) of FIG. 2).

According to the present invention, the number of the regions for the backlight is not limited to a specific one. The number of the regions can be either one or a plural number. Shapes of the respective regions are not also limited to a specific one. Moreover, the regions for the backlight are not necessarily identical in size and shape.

According to such a configuration where regions are secured for a backlight, it is necessary to control the emission luminance of each of the regions. The following briefly describes a specific controlling method.

For example, in cases where a light source that is used as the backlight is a light source whose emission luminance can be controlled in accordance with a supplied voltage, it is possible to employ a configuration in which different voltage supplying systems are employed for supplying voltages to the respective regions so that the respective regions have their own necessary emission luminance. Alternatively, in cases where a light source that is used as the backlight is a light source whose emission luminance can be controlled by controlling an emission period of the light source, it is possible to employ a configuration in which control signals for controlling emission periods of the respective regions are separately supplied.

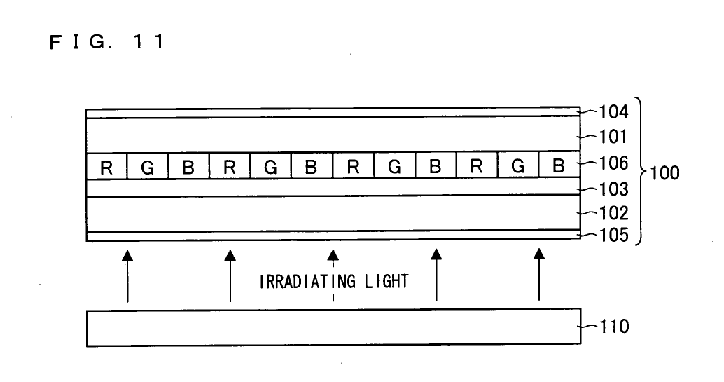

The display panel 4 is a typical transmissive liquid crystal panel as illustrated, for example, in FIG. 11, and carries out display control by controlling a voltage that is applied to the liquid crystal layer so that the amount of the light, emitted from the backlight 3, which travels through the liquid crystal panel is controlled for each pixel.

The control section 5, including a CPU (central processing unit), controls operations of respective various components of the liquid crystal display device 10 comprehensively. The control section 5 includes a comparison process section 51, a lighting state detection section 52, a backlight failure detection section 53, and a notification control section 54.

The comparison process section 51 (i) judges whether or not the voltage supplied to the inverter section 2 from the power supply section 1 is not less than a predetermined voltage, and (ii) outputs a judged result to the backlight failure detection section (described later). The predetermined voltage is a voltage, set in advance, which is required for driving the inverter section 2 properly. Accordingly, in a case where a voltage supplied from the power supply section 1 is less than the predetermined voltage, the inverter section 2 does not operate normally. It follows that the backlight 3 does not light normally. Note that a state where the backlight 3 does not light normally encompasses not only a state where the backlight 3 does not light at all, but also a state where the backlight 3 does not light sufficiently (an incomplete lighting state) due to a low voltage for driving the inverter section 2. In the following descriptions, the incomplete lighting state is referred to as a state where the backlight is lighting improperly or the backlight is not lighting. In Embodiment 1, the predetermined voltage is set to 60 V.

The lighting state detection section 52 detects a lighting state of the backlight 3, and then outputs a detected result to the backlight failure detection section 53. Specifically, the lighting state detection section 52 detects whether the backlight 3 is lighting properly or not lighting properly, and then outputs a signal (High or Low) indicative of a detected result to the backlight failure detection section 53. The configuration of the lighting state detection section 52 will be described later in more concrete terms.

In accordance with the signals, received from the comparison process section 51 and the lighting state detection section 52, the backlight failure detection section 53 judges whether or not the backlight 3 has failed, and then outputs a judged result to the notification control section 54.

The notification control section 54 controls the notification section 6 in accordance with the signal received from the backlight failure detection section 53. Specifically, the notification control section 54 commands the notification section 6 to notify outside of the lighting state of the backlight 3.

The notification section 6, provided near the display panel 4, notifies outside of the lighting state of the backlight 3 and a state of failure in the liquid crystal display device 10. Examples of specific notification means include a configuration in which an indicator display is performed by an externally viewable LED, a configuration in which a message is displayed on a notification section having a display function, and a configuration in which an externally identifiable sound is produced.

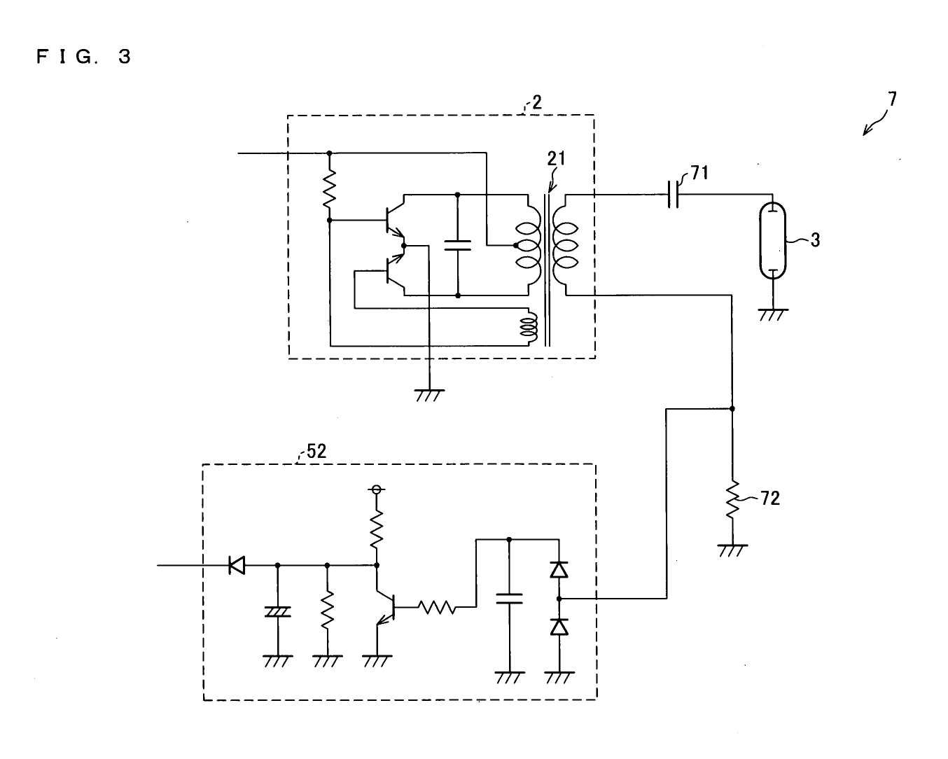

An example of the configuration of the lighting state detection section 52 is described in more concrete terms with reference to FIG. 3. FIG. 3 is a circuit configuration schematically illustrating the configuration of a backlight unit 7 including the inverter section 2, the lighting state detection section 52, and the backlight 3. As illustrated in FIG. 3, the backlight unit 7 includes: an inverter transformer 21, a ballast capacitor 71; the backlight 3; a resistor (tube current detection resistor) 72 for detecting a tube current that flows while the backlight 3 is lighting; and the lighting state detection section 52, which detects a lighting state of the backlight 3 by detecting a voltage across the tube current detection resistor 72.

While the backlight 3 is lighting normally, an alternating voltage is generated across the tube current detection resistor 72. On the other hand, in cases where the backlight 3 is not lighting normally, no current flows between the backlight 3 and the inverter transformer 21 any longer. This causes no alternating voltage to be generated across the tube current detection resistor 72. Thus, it is possible that the lighting state detection section 52 detects a lighting state of the backlight 3 by measuring a voltage across the tube current detection resistor 72.

Note that the lighting state detection section 52 is not limited to such a configuration, provided that it is possible to determine whether the backlight is lighting (normal lighting state) or not lighting (abnormal lighting state). Consequently, another configuration of the lighting state detection section 52 can be realized by a light-receiving element such as a PD (photodiode). The light-receiving element is provided near the backlight 3 so as to receive the light emitted from the backlight 3 and output a signal which varies according to an amount of light thus received. This makes it possible to detect the lighting state of the backlight 3 in accordance with the amount of light emitted by the backlight 3.

(Operation Example 1 of the Liquid Crystal Display Device 10)

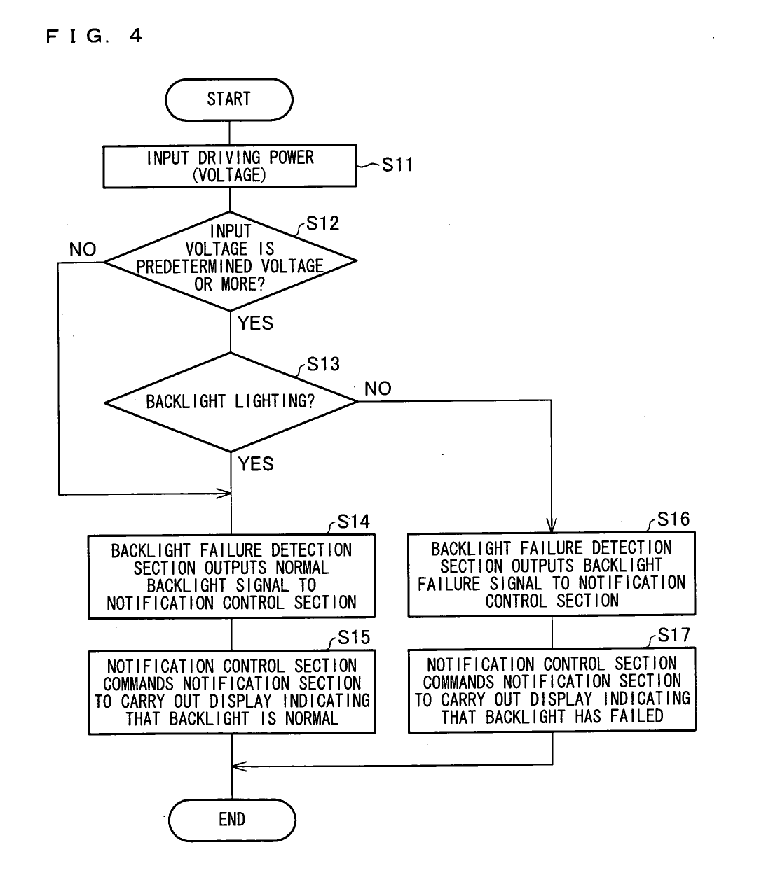

The following description deals with the functions of the respective sections of the liquid crystal display device 10 with reference to FIGS. 1 and 4 together with their respective specific operations. FIG. 4 is a process flow chart showing an operation of the liquid crystal display device 10 in the present configuration example 1-1.

First, in Step 11 (hereinafter abbreviated as in “S11”) of FIG. 4, after the power supply section 1 is externally supplied with AC 100 V, the power supply section 1 supplies the inverter section 2 with driving electric power (voltage) which causes the inverter section 2 to be driven. Next, the comparison process section 51 judges whether or not the voltage supplied to the inverter section 2 from the power supply section 1 is not less than a predetermined voltage (in this case, 60 V), and then outputs a judged result to the backlight failure detection section 53 (S12). In a case where the voltage is not less than the predetermined voltage (YES in S12), the lighting state detection section 52 detects whether the backlight 3 is lighting or not lighting, and then outputs a detected result to the backlight failure detection section 53 (S13). The control section 5 (i) commands the comparison process section 51 to output, to the lighting state detection section 52, the result indicative of whether or not the voltage is not less than the predetermined voltage, and (ii) also commands the lighting state detection section to detect whether the backlight 3 is lighting or not lighting.

Next, upon receiving, from the lighting state detection section 52, a signal indicating that the backlight 3 is lighting normally (YES in S13), the backlight failure detection section 53 determines that the backlight 3 is not failed but normal, and then outputs, to the notification control section 54, a normal signal (normal backlight signal) (S14). Upon receiving the normal backlight signal, the notification control section 54 commands the notification section 6 to notify outside that the backlight 3 is lighting (S15). Specifically, for example, the notification control section 54 causes an LED indicator provided in the display panel 4 to carry out a lighting process for indicating that the backlight 3 is normal, more specifically, a process for “lighting the LED indicator in blue”. Alternatively, the notification control section 54 causes a notification section 6 having a display function to display a message indicating that the backlight 3 is lighting normally. This makes it possible to externally confirm that the backlight 3 is lighting normally.

On the other hand, upon receiving, from the lighting state detection section 52, a signal indicating that the backlight 3 is not lighting normally (NO in S13), the backlight failure detection section 53 determines that the backlight 3 has failed, and then outputs, to the notification control section 54, an error signal (backlight failure signal) (S16). Upon receiving the backlight failure signal, the notification control section 54 commands the notification section 6 to notify outside that the backlight 3 is not lighting (S17). Specifically, for example, the notification control section 54 causes the LED indicator provided in the display panel 4 to carry out a lighting process for indicating that the backlight 3 has failed, more specifically, a process for “blinking the LED indicator in red”. Alternatively, the notification control section 54 causes the notification section 6 having a display function to display a message indicating that the backlight 3 has failed. This makes it possible to externally confirm that the backlight 3 has failed.

On the other hand, in a case of being judged as NO in S12, that is, in a case where the voltage supplied to the inverter section 2 from the power supply section 1 is less than the predetermined voltage, the inverter section 2 cannot be driven normally. This causes the backlight 3 not to light normally. According to the conventional liquid crystal display device, the failure of the backlight 3 is judged based on the state where the backlight 3 does not light. In contrast, according to the liquid crystal display device 10 in Embodiment 1, in a case where a voltage supplied to the inverter section 2 from the power supply section 1 is less than the predetermined voltage, the backlight failure detection section 53 does not determine that the backlight 3 has failed and therefore does not output a backlight failure signal, even though the backlight 3 does not light.

Accordingly, in a case where a voltage supplied to the inverter section 2 from the power supply section 1 is less than the predetermined voltage (NO in S12), the process of S13 is skipped, and the process proceeds to S14. In S14, the backlight failure detection section 53 outputs, to the notification control section 54, a signal indicating that the backlight is normal. This causes (i) an LED indicator provided in the display panel 4 to carry out a process for “lighting the LED indicator in blue” which indicates that the backlight 3 is normal, or (ii) the notification section 6 having a display function to display a message indicating that the backlight is lighting normally.

As such, according to the liquid crystal display device 10 of the present configuration example 1-1, the backlight failure signal is not outputted regardless of the lighting state of the backlight 3 particularly in a case where a voltage supplied to the inverter section 2 is less than the predetermined voltage. That is, the liquid crystal display device 10 does not output a backlight failure signal even while the backlight 3 is not lighting normally.

According to the configuration, for example, even though the LED indicator indicates that the backlight 3 is normal, the display panel 4 itself does not display normally. This allows the user or the operator to recognize that the improper display of the display panel 4 is not caused by a failure of the backlight 3. Instead, the user or the operator can surmise that the cause is not due to the backlight but is due to the power supply section 1 which supplies a voltage to the inverter section 2. Accordingly, it is possible to omit to check for the backlight 3 side, that is, the inverter 2, backlight 3, and their peripheral parts, for which the check has been required in conventional maintenance work. This allows the maintenance work to be carried out efficiently.

(Operation Example 2 of the Liquid Crystal Display Device 10)

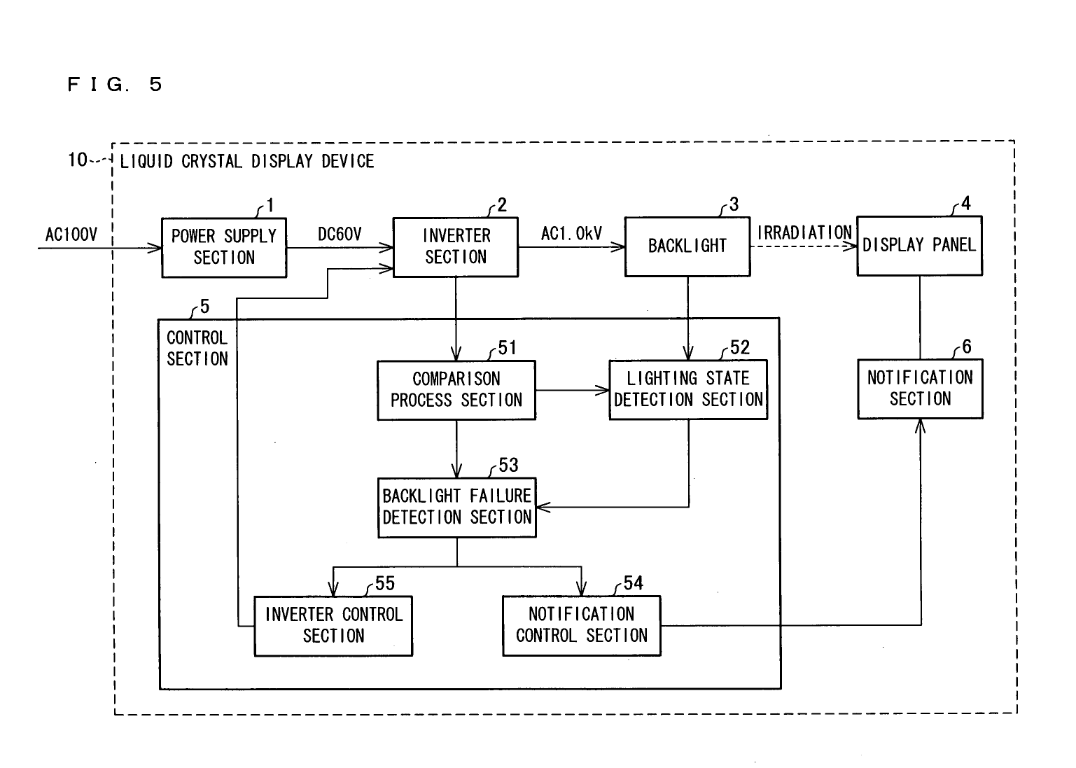

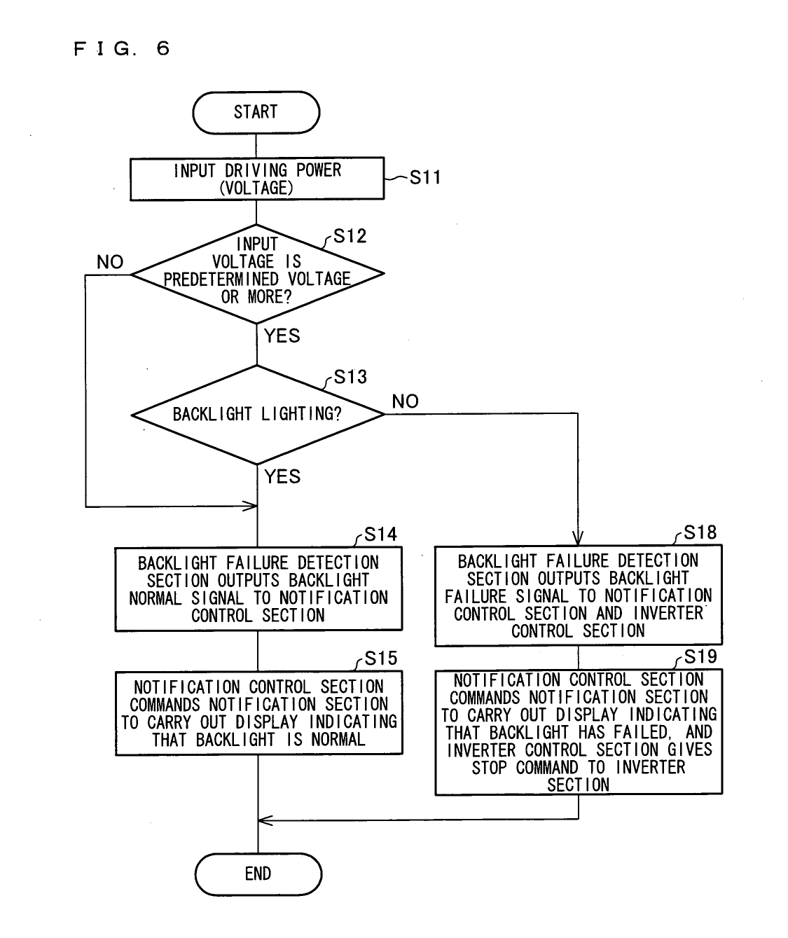

In a case where the backlight 3 has failed due to a certain cause, a transformer output is in an unloaded condition, so that the transformer output voltage rises abnormally. This will cause various dangers such as discharge, firing, and an electrical shock to the operator. In view of this, it is preferable that the liquid crystal display device 10 of Embodiment 1 includes, in addition to the configuration example 1-1, a configuration for causing the inverter section 2 to stop driving when the backlight 3 has failed. As shown in FIG. 5, the configuration (hereinafter, referred to as configuration example 1-2) of the liquid crystal display device 10 includes an inverter control section 55 in addition to the configuration shown in FIG. 1. The following describes the configuration example 1-2 of the liquid crystal display device 10 and concrete operations with reference to FIGS. 5 and 6.

FIG. 6 is a process flow chart illustrating an operation of the liquid crystal display device 10 in the configuration example 1-2. Note that the processes in S11 to S15 are the same as those in the process flow of the liquid crystal display device 10 in the configuration example 1-1 shown in FIG. 4. Accordingly, detailed explanations are omitted as to the processes in S11 to S15.

In a case where (i) a voltage supplied to the inverter section 2 from the power supply section 1 is not less than the predetermined voltage (60V) (YES in S12) and (ii) the backlight 3 is not lighting normally (NO in S13), a backlight failure signal is outputted from the backlight failure detection section 53 to both the notification control section 54 and the inverter control section 55 (S18). Further, the notification control section 54 commands the notification section 6 to notify outside that the backlight 3 is not lighting, and the inverter control section 55 commands the inverter section 2 to stop driving (S19). The inverter control section 55 is configured to control the operation of the inverter section 2 in response to the signal outputted from the backlight failure detection section 53.

With the configuration, in a case where the backlight 3 has failed, it is possible to cause the inverter section 2 to stop. This causes no voltage to be supplied to the backlight 3 from the inverter 2. Accordingly, it is possible to avoid the above described various dangers such as discharge, firing, and an electrical shock to the operator.

### Embodiment 2

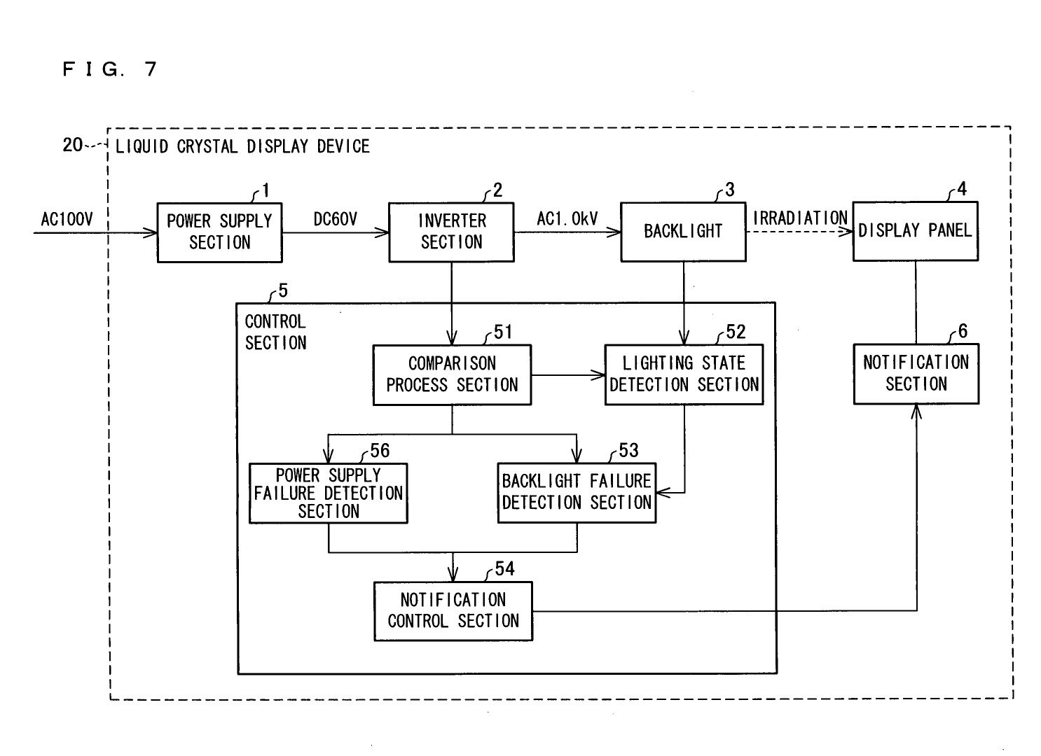

The following describes another embodiment of the present invention with reference to FIGS. 7 to 10. Note that, the present Embodiment 2 also describes the liquid crystal display device 10 of the above Embodiment 1 as an example.

Moreover, for convenience of explanation, members having the same functions as those described in Embodiment 1 are given the same reference numerals, and explanations of the members are omitted. Further, the terms defined in Embodiment 1 are also used in Embodiment 2 according to the definition, unless otherwise noted.

According to the liquid crystal display device 10 of Embodiment 1, in a case where the voltage supplied to the inverter section 2 from the power supply section 1 is less than the predetermined voltage, no backlight failure signal is outputted, regardless of the lighting state of the backlight 3. That is, in the liquid crystal display device 10, even while the backlight 3 is not lighting normally, the backlight failure signal is not outputted, and the display panel 4 carries out a display indicating that the backlight 3 is normal.

On the other hand, according to a liquid crystal display device 20 of Embodiment 2, in a case where a voltage supplied to the inverter section 2 from the power supply section 1 is less than the predetermined voltage, an error signal (power supply failure signal) indicating that the power supply section 1 has failed is outputted. The following specifically describes a configuration of the liquid crystal display device 20. FIG. 7 is a block diagram illustrating a schematic structure of the liquid crystal display device 20 in accordance with Embodiment 2. Note that the configuration shown in FIG. 7 is hereinafter referred to as a configuration example 2-1.

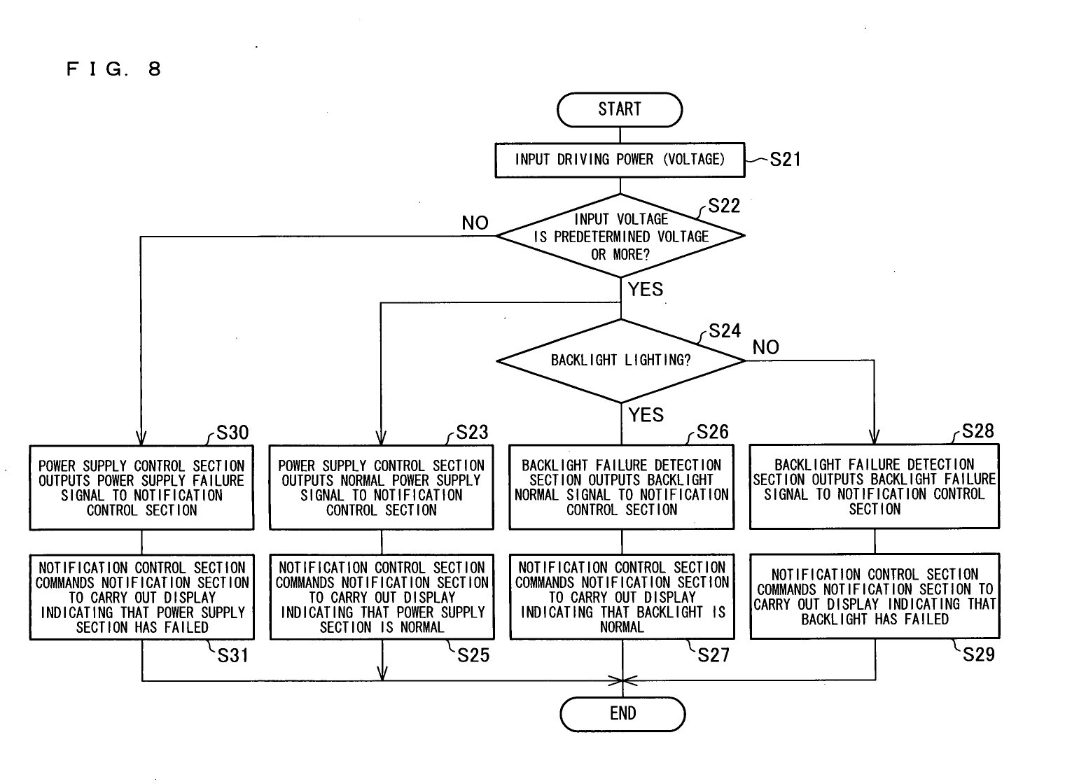

As shown in FIG. 7, the liquid crystal display device 20 of the configuration example 2-1 includes a power supply failure detection section 56 in addition to the configuration of the liquid crystal display device 10 in the configuration example 1-1 of Embodiment 1 shown in FIG. 1. The power supply failure detection section 56 (i) receives, from the comparison process section 51, a judged result as to whether or not a voltage supplied from the power supply section 1 is not less than the predetermined voltage, and then (ii) carries out a process in accordance with the judged result. The following describes a specific process and an operation of the liquid crystal display device with reference to FIGS. 7 and 8. FIG. 8 is a process flow chart illustrating the operation of the liquid crystal display device 20 in the configuration example 2-1.

(Operation Example 1 of the Liquid Crystal Display Device 20)

First, in S21 shown in FIG. 8, a driving voltage is supplied to the inverter section 2 from the power supply section 1. Then, the comparison process section 51 judges whether or not the voltage supplied to the inverter section 2 form the power supply section 1 is not less than the predetermined voltage (in this case, 60 V), and outputs a judged result to the power supply failure detection section 56 and the backlight failure detection section 53 (S22). In a case where the voltage is not less than the predetermined voltage (YES in S22), (i) the power supply failure detection section 56 determines that the power supply section 1 is normal, and then outputs, to the notification control section 54, a normal signal (normal power supply signal) indicating that the power supply section 1 is normal (S23) and (ii) the lighting state detection section 52 judges whether or not the backlight 3 is lighting normally, and then outputs a judged result to the backlight failure detection section 53 (S24).

In a case where the notification control section 54 receives the signal indicating that the power supply section 1 is normal, it commands the notification section 6 to notify outside that the power supply section 1 is normal (S25). In a case where the backlight failure detection section 53 receives, from the lighting state detection section 52, a signal indicating that the backlight 3 is lighting normally (YES in S24), the backlight failure detection section 53 (i) determines that the backlight has not failed but is normal, and then (ii) outputs, to the notification control section 54, a normal signal (normal backlight signal) indicating that the backlight 3 is normal (S26). The notification control section 54, which has received the normal backlight signal, commands the notification section 6 to notify outside of the lighting state of the backlight 3 (S27).

In a specific configuration of the notification section 6 in Embodiment 2, for example, the display panel 4 is provided with a first LED indicator for the power supply section 1 and a second LED indicator for the backlight 3. The first and second indicators are subjected to first and second lighting processes so as to indicate that the power supply section 1 and the backlight 3 are normal, respectively. More specifically, the first and second lighting processes cause the first and second indicators to “light in blue and to light in blue”, respectively. This makes it possible to externally confirm that both the power supply section 1 and the backlight 3 are normal.

On the other hand, in a case where the backlight failure detection section 53 receives, from the lighting state detection section 52, a signal indicating that the backlight 3 is not lighting normally (NO in S24), the backlight failure detection section 53 determines that the backlight 3 has failed, and then outputs, to the notification control section 54, a backlight failure signal indicating that the backlight 3 has failed (S28). The notification control section 54, which has received the backlight failure signal, commands the notification section 6 to notify outside that the backlight 3 is not lighting (S29). For example, the first and second LED indicators are subjected to first and second lighting processes so as to indicate that the power supply section 1 is normal and the backlight 3 has failed, respectively. More specifically, the first and second lighting processes cause the first and second LED indicators to “light in blue and to blink in red”, respectively. This makes it possible to externally confirm that the power supply section 1 is normal and the backlight 3 has failed.

On the other hand, in a case of being judged as NO in S22, that is, in a case where the voltage supplied to the inverter section 2 from the power supply section 1 is less than the predetermined voltage, the power supply failure detection section 56 determines that the power supply section 1 has failed, and then outputs, to the notification control section 54, a power supply failure signal indicating that the power supply section 1 has failed (S30). The notification control section 54, which has received the signal indicating that the power supply section 1 has failed, commands the notification section 6 to notify outside that the power supply section 1 has failed (S31). For example, the first and second LED indicators are subjected to first and second lighting processes so as to indicate that the power supply section 1 has failed and the backlight 3 has not failed, respectively. More specifically, the first and second lighting processes cause the first and second LED indicators to “blink in red and to light in blue”, respectively. This makes it possible to externally confirm that the power supply section 1 has failed and the backlight 3 has not failed.

Note in this case that the inverter section 2 does not receive a voltage of not less than the predetermined voltage, and therefore the backlight 3 does not light. However, the backlight failure detection section 53 does not determine that the backlight 3 has failed, and therefore does not output the backlight failure signal. Accordingly, the second LED indicator is subjected to the second process so as to indicate that the backlight 3 is normal. The second process causes the second LED indicator to “light in blue”.

Thus, according to the configuration of the liquid crystal display device 20 in accordance with the present configuration example 2-1, in a case where a voltage supplied to the inverter section 2 is less than the predetermined voltage, (i) the backlight failure signal is not outputted regardless of the lighting state of the backlight 3 and (ii) a signal indicating the failure of the power supply 1 is outputted.

According to the configuration, for example, the indicators in the display panel 4 does not carry out a display indicating that the backlight 3 has failed but carries out a display indicating that the power supply section 1 has failed. This allows the user or the operator to recognize that the improper display of the display panel 4 is not caused by a failure of the backlight 3 but is caused by a failure of the power supply section 1. In particular, according to the liquid crystal display device 20 of Embodiment 2, the failure of the power supply section 1 is displayed. On this account, the cause for which the display panel 4 does not display can easily be identified, as compared to the configuration of the liquid crystal display device 10 in the above described Embodiment 1.

(Operation Example 2 of the Liquid Crystal Display Device 20)

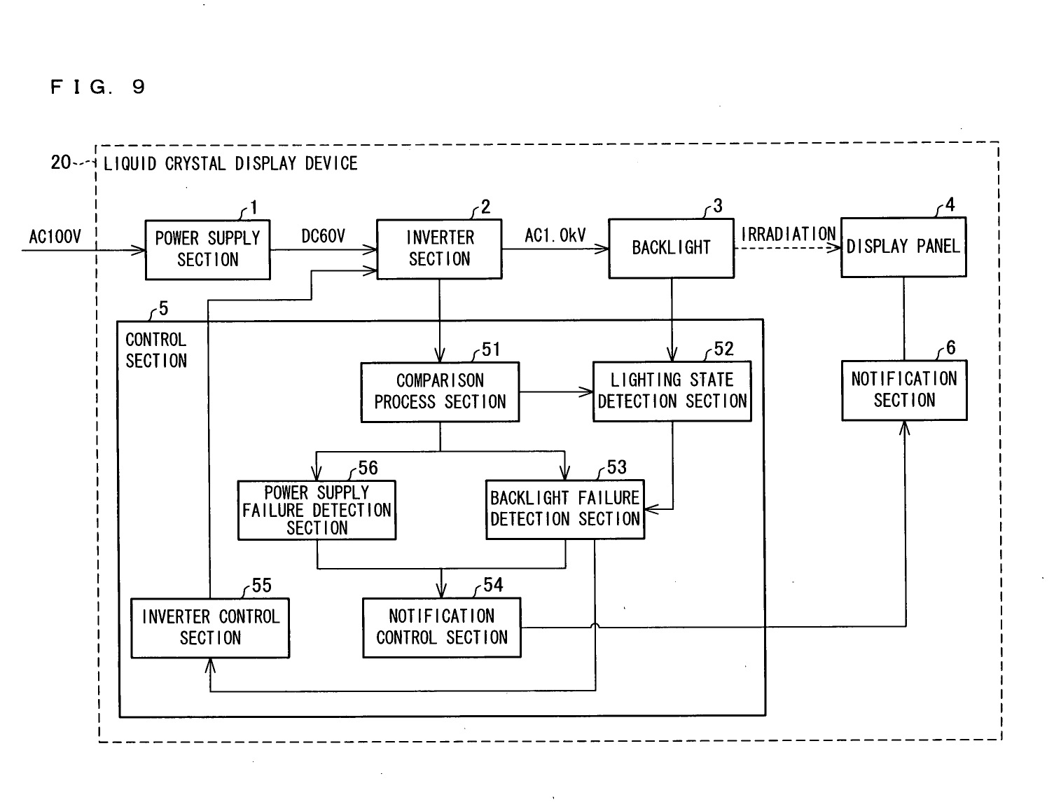

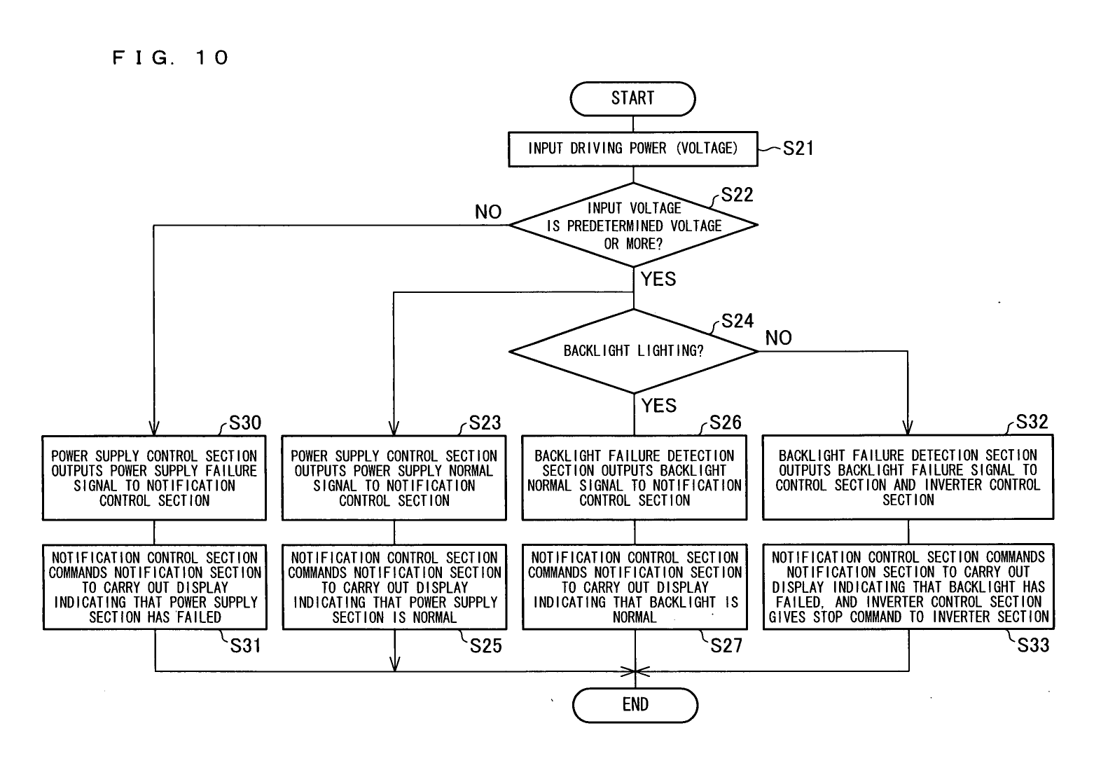

In order to avoid the various dangers, such as discharge, firing, and an electrical shock to the operator, which are similar to the failure of the backlight 3, it is preferable that the liquid crystal display device 20 in Embodiment 2 also includes the configuration for causing the inverter section 2 to stop driving when the backlight 3 has failed, as with the liquid crystal display device 10 of the configuration example 1-2 in Embodiment 1. As shown in FIG. 9, the liquid crystal display device 20 having the configuration (hereinafter, referred to as configuration example 2-2) includes an inverter control section 55, in addition to the configuration shown in FIG. 7. The following describes the configuration example 2-2 and its specific operation with reference to FIGS. 9 and 10.

FIG. 10 is a process flow chart illustrating an operation of the liquid crystal display device 20 in the configuration example 2-2. Note that the processes in S21 to S31, except for the process S29, are the same as those in the process flow of the liquid crystal display device 20 in the configuration example 2-1 shown in FIG. 8. Accordingly, detailed explanations of these processes are omitted.

In a case where (i) a voltage supplied to the inverter section 2 from the power supply section 1 is not less than the predetermined voltage (60V) (YES in S22) and (ii) the backlight 3 is not lighting normally (NO in S23), a backlight failure signal is outputted from the backlight failure detection section 53 to the notification control section 54 and the inverter control section 55 (S32). Further, (i) the notification control section 54 commands the notification section 6 to notify outside that the backlight 3 is not lighting, and (ii) the inverter control section 55 commands the inverter section 2 to stop driving (S33). Thus, the inverter control section 55 controls the operation of the inverter section 2 in response to the signal supplied from the backlight failure detection section 53.

With the configuration, in a case where the backlight 3 has failed, the inverter section 2 stops driving. This causes no voltage to be applied to the backlight 3 from the inverter section 2. Accordingly, it is possible to avoid the above described various dangers such as discharge, firing, and an electrical shock to the operator.

Although the Embodiments 1 and 2 deals with the example where the present invention is applied to a liquid crystal device, the present invention can also be applied to a general transmissive display device in a similar manner.

Finally, the blocks of each of the liquid crystal display devices in Embodiments 1 and 2, in particular, the comparison process section 51, the lighting state detection section. 52, the backlight failure detection section 53, the notification control section 54, the inverter control section 55, and the power supply failure detection section 56 can be realized by hardware or can be realized by software with the use of a CPU as follows:

Each of the liquid crystal display devices 10 and 20 includes a CPU (central processing unit), a ROM (read only memory), a RAM (random access memory), and a memory device (memory medium) such as a memory. The CPU executes instructions in control programs for realizing each function. The ROM contains a program, the program is loaded on the RAM, and the memory device stores the program and various data. The objective of the present invention can also be achieved, by mounting to the liquid crystal display device 10 or 20 a computer-readable storage medium storing control program codes (executable program, intermediate code program, or source program) for the liquid crystal display device 10 or 20, serving as software for realizing the foregoing respective functions, so that the computer (or CPU or MPU) retrieves and executes the program code stored in the storage medium.

The storage medium can be, for example, a tape, such as a magnetic tape or a cassette tape; a disk including (i) a magnetic disk such as a floppy (Registered Trademark) disk or a hard disk and (ii) an optical disk such as CD-ROM, MO, MD, DVD, or CD-R; a card such as an IC card (memory card) or an optical card; or a semiconductor memory such as a mask ROM, EPROM, EEPROM, or flash ROM.

Alternatively, the liquid crystal display device 10 or 20 can be arranged to be connectable to a communications network so that the program codes are delivered over the communications network. The communications network is not limited to a specific one, and therefore can be, for example, the Internet, an intranet, extranet, LAN, ISDN, VAN, CATV communications network, virtual private network, telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR, mobile telephone network, satellite line, or terrestrial digital network. Note that, the present invention can be realized by a computer data signal (i) which is realized by electronic transmission of the program code and (ii) which is embedded in a carrier wave.

The liquid crystal display devices 10 and 20 can be thus realized by a computer. In a case where the computer is caused to operate as the respective blocks, (i) a control program for causing each of the respective liquid crystal display devices 10 and 20 to be realized by the computer and (ii) a computer-readable storage medium storing the control program fall within the scope of the present invention.

The present invention is not limited to the description of the embodiments above, but can be altered by a skilled person in the art within the scope of the claims. An embodiment derived from a proper combination of technical means disclosed in respective different embodiments is also encompassed in the technical scope of the present invention.

As described above, in the liquid crystal display device of the present invention: the back light failure detection section outputs a backlight failure signal indicating that the backlight has failed, in a case where (i) the voltage supplied to the inverter section is not less than the predetermined voltage and (ii) the backlight is not lighting normally; and the backlight failure detection section does not output the backlight failure signal in a case where the voltage supplied to the inverter section is less than the predetermined voltage.

Moreover, as described above, according to the method for driving the display device of the present invention: in the step of judging whether of not the backlight has failed, a backlight failure signal, indicating that the backlight has failed, is outputted in a case where (i) the voltage supplied to the inverter section is not less than the predetermined voltage and (ii) the backlight is not lighting normally; and in the step, the backlight failure signal is not outputted in a case where the voltage supplied to the inverter section is less than the predetermined voltage.

Accordingly, even though the display panel does not display normally, the backlight failure signal is not outputted. This allows the user or the operator to recognize that a cause of the improper display of the display panel is not a failure of the backlight. Accordingly, it is possible to identify the cause of the improper lighting of the backlight. This allows the maintenance work to be carried out efficiently.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The display device of the present invention is applicable to a liquid crystal display device including a backlight, because the backlight failure signal is not outputted in a case where the voltage supplied to the inverter section is less than the predetermined voltage. Accordingly, the cause of the improper lighting of the backlight can be identified. This allows the maintenance work to be carried out efficiently.

1. A display device comprising (i) a transmissive display panel, (ii) a backlight that irradiates the display panel with light, and (iii) an inverter section that supplies a driving voltage to the backlight, in which a display is carried out by controlling an amount of transmission of the light with which the display panel is irradiated by the backlight,
said display device, further comprising:
a comparison process section that judges whether or not a voltage supplied to the inverter section is not less than a predetermined voltage required for normally driving the inverter section;
a lighting state detection section that detects a lighting state of the backlight; and
a backlight failure detection section that (i) judges whether or not the backlight has failed, in accordance with a judged result of the comparison process section and a detected result of the lighting state detection section and (ii) outputs a signal which varies according to its judged result,
the backlight failure detection section outputting a backlight failure signal indicating that the backlight has failed, in a case where (i) the voltage supplied to the inverter section is not less than the predetermined voltage and (ii) the backlight is not lighting normally, and
the backlight failure detection section outputting no backlight failure signal, in a case where the voltage supplied to the inverter section is less than the predetermined voltage.

2. The display device as set forth in claim 1, wherein:
the backlight failure detection section outputs a signal indicating that the backlight is normal, in a case where (i) the voltage supplied to the inverter section is not less than the predetermined voltage and (ii) the backlight is lighting normally;
the backlight failure detection section outputs a backlight failure signal indicating that the backlight has failed, in a case where (i) the voltage supplied to the inverter section is not less than the predetermined voltage and (ii) the backlight is not lighting normally; and
the backlight failure detection section outputs no backlight failure signal, in a case where the voltage supplied to the inverter section is less than the predetermined voltage.

3. A display device as set forth in claim 1, further comprising:
a notification section that notifies outside of the lighting state of the backlight; and
a notification control section that gives a notification command to the notification section in accordance with an output signal supplied from the backlight failure detection section so as to cause the notification section to notify outside of the lighting state of the backlight,
the notification control section sending, to the notification section, a signal for causing the notification section to notify outside that the backlight has failed, in a case where the notification control section receives the backlight failure signal, and
the notification control section sending, to the notification section, no signal for causing the notification section to notify outside that the backlight has failed, in a case where the notification control section receives no backlight failure signal.

4. A display device as set forth in claim 1, further comprising:
a notification section that notifies outside of the lighting state of the backlight; and
a notification control section that gives a notification command to the notification section so as to cause the notification section to notify outside of the lighting state of the backlight,
the notification control section sending, to the notification section, a signal for causing the notification section to notify outside that the backlight has failed, in a case where the notification control section receives the backlight failure signal, and
the notification control section sending, to the notification section, a signal for causing the notification section to notify outside that the backlight is normal, in a case where the notification control section receives no backlight failure signal.

5. A display device as set forth in claim 1, further comprising:
a power supply failure detection section that (i) judges whether or not the power supply section has failed in accordance with a judged result of the comparison process section and (ii) outputs a signal which vanes according to its judged result,
the power supply failure detection section outputting a power supply failure signal indicating that the power supply section has failed, in a case where the voltage supplied to the inverter section is less than the predetermined voltage.

6. A display device as set forth in claim 5, further comprising:
a notification section that notifies outside of the lighting state of the backlight; and
a notification control section that gives a notification command to the notification section in accordance with output signals of the backlight failure detection section and the power supply failure detection section so as to cause the notification section to notify outside of (i) the lighting state of the backlight and (ii) a state of the power supply section,
the notification control section (i) sending, to the notification section, a signal for causing the notification section to notify outside that the power supply section has failed but (ii) sending, to the notification section, no signal for causing the notification section to notify outside that the backlight has failed, in a case where the notification control section receives the power supply failure signal.

7. A display device as set forth in claim 5, further comprising:
a notification section that notifies outside of the lighting state of the backlight; and
a notification control section that gives a notification command to the notification section in accordance with output signals of the backlight failure detection section and the power supply failure detection section so as to cause the notification section to notify outside of (i) the lighting state of the backlight and (ii) a state of the power supply section,
the notification control section (i) sending, to the notification section, a signal for causing the notification section to notify outside that the power supply section has failed and (ii) sending, to the notification section, a signal for causing the notification section to notify outside that the backlight is normal, in a case where the notification control section receives the power supply failure signal.

8. A display device as set forth in claim 1, further comprising:
an inverter control section that controls whether to drive or stop the inverter section in accordance with an output signal of the backlight failure detection section,
the inverter control section controlling the inverter section to stop supplying a voltage to the backlight, in a case where the inverter control section receives the backlight failure signal.

9. The display device as set forth in claim 3, wherein the notification section is constituted by an externally viewable indicator display.

10. The display device as set forth in claim 3, wherein the notification section is constituted by a speaker that produces a sound by which the lighting state of the backlight can be identified.

11. The display device as set forth in claim 1, wherein the lighting state detection section judges the lighting state of the backlight by detecting an output voltage of a transformer in the inverter section, the output voltage being supplied to the backlight.

12. The display device as set forth in claim 1, wherein the lighting state detection section judges the lighting state of the backlight by detecting an amount of light with which the display panel is irradiated by the backlight.

13. The display device as set forth in claim 1, wherein the display device is a liquid crystal display device.

14. A method for driving a display device,
said display device comprising (i) a transmissive display panel, (ii) a backlight that irradiates the display panel with light, and (iii) an inverter section that supplies a driving voltage to the backlight, in which a display is carried out by controlling an amount of transmission of the light with which the display panel is irradiated by the backlight,
said method comprising the steps of:
(a) judging whether or not a voltage supplied to the inverter section is not less than a predetermined voltage required for normally driving the inverter section;
(b) detecting a lighting state of the backlight; and
(c) judging whether or not the backlight has failed, in accordance with a judged result in the step (a) and a detected result in the step (b), and outputting a signal which varies according to its judged result,
in the step (c), a backlight failure signal, indicating that the backlight has failed, being outputted in a case where (i) the voltage supplied to the inverter section is not less than the predetermined voltage and (ii) the backlight is not lighting normally, and
in the step (c), no backlight failure signal being outputted in a case where the voltage supplied to the inverter section is less than the predetermined voltage.
